(19) United States
(12) Patent Application Publication
(10) Pub. No.: US 2024/0362653 A1
(43) Pub. Date: Oct. 31, 2024

(54) revolutionary, disruptive, redefining and changing modern business rules modern macroeconomics, modern microeconomics, process of human being civilization and human being civilization's way or the method and the method or model or the platform created to implement this method

(71) Applicant: CHUANPING HU, Zhengzhou Henan (CN)

(72) Inventor: CHUANPING HU, Zhengzhou Henan (CN)

(21) Appl. No.: 18/139,963

(22) Filed: Apr. 27, 2023

(51) Int. Cl. G06Q 30/0201

(52) U.S. Cl. CPC G06Q 30/0201

(57) ABSTRACT

This method, platform or patent is planned economy under a market economy, eliminates random or blind production by factories and random or blind consumption by consumers and supply according to demand all people in the world from birth to death with the best product, goods, and service quality and the lowest prices through “non-retail” in a non-traditional sense, “no fixed cost expenses such as bank interest required by typical businesses,” “eliminating random or blind production by manufacturers and consumption by consumers,” “thoroughly eliminating waste in the production and consumption process,” “substituting, eliminating, and thoroughly eliminating inefficient small, medium, large, and even huge enterprises in every industry for every product, commodity, or service,” “consumers being able to buy the best quality, lowest price, and best value products, commodities, or services in the world,” “saving people's time and money in consumption,” “helping the poor and reducing poverty,” “green and low-carbon,” “helping to address global climate change,” and so on. Therefore, this method, this platform, and this patent change the way people work and live, as well as the way enterprises produce products in the production process.

This patent represents a revolutionary and disruptive redefinition, reshaping, and replacement of modern economic theory, including micro and macroeconomics, since the patent changes, replaces, disrupts, redefines, and reshapes modern business rules and revolutionizes and redefines the course of human civilization and human civilization itself.

This method will establish a wave that includes Industry 4.0 or 5.0, and transform manufacturing into a service industry this method eliminates the traditional concept of primary, secondary, and tertiary industries and merge into one.

Producers under the method or patent have no advertising expenses, no sales expenses or costs, and no market expenses or costs even no financial costs, This method's revolutionary and transformative reshaping and redefining of the traditional financial industry, especially the banking sector, and human social and economic activities. This method will help and serve almost all consumers from birth to near-death around the world save time and money, optimize the way they spend their money, helps poor people and reduces the poverty rate, eliminates waste in various industries from production to consumption, therefore, is environmentally friendly and low-carbon and effectively respond to global climate change.

### ADVANTAGEOUS EFFECTS: ONE

1. This method (model), this platform, this patent, this platform, and this patent are planned economy and supply according to demand under a market economy.
2. Supply all products, goods, and services needed by all people in the world from birth to death.
3. With the best product, goods, and service quality and the lowest prices among similar products.
4. Supply and distribute according to demand through “non-retail” in a non-traditional sense.
5. Through artificial intelligence (based on big data, cloud computing, 5G, the Internet, the Internet of Things, etc.).
6. In a “non-retail” way that is different from the traditional concept of wholesale.
7. That is, the products go directly from production through this method, model, and platform to the hands of consumers.
8. This method can be described or expressed in digital form as follows: For

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m}.
9. This method, this platform, and this patent claim a revolutionary and disruptive redefinition and reshaping of modem business rules, replacing them with claims including but not limited to “new retail enabling manufacturers and consumers to transact directly through this platform,” “planned economy under a market economy,” “on-demand production, supply, and distribution,” “no fixed cost expenses such as bank interest required by typical businesses,” “eliminating random or blind production by manufacturers and consumption by consumers,” “thoroughly eliminating waste in the production and consumption process,” “substituting, eliminating, and thoroughly eliminating inefficient small, medium, large, and even huge enterprises in every industry for every product, commodity, or service,” “consumers being able to buy the best quality, lowest price, and best value products, commodities, or services in the world,” “saving people's time and money in consumption,” “helping the poor and reducing poverty,” “green and low-carbon,”
   “helping to address global climate change,” and so on. Therefore, this method, this platform, and this patent change the way people work and live, as well as the way enterprises produce products in the production process.
10. This method, this platform, and this patent represent a revolutionary and disruptive redefinition, reshaping, and replacement of modern economic theory, including micro and macroeconomics, because they change, replace, disrupt, redefine, and reshape modern business rules, which constitute the core and foundation of modern economic theory to a considerable extent.
11. This method, this platform, and this patent represent a revolutionary and disruptive redefinition, reshaping, and change in the course of human civilization and human civilization itself. The revolutionary and disruptive redefinition and reshaping of modern business rules by this method, this platform, and this patent also changes the consumption behavior of people as consumers and the production behavior of enterprises in the production process. Therefore, it revolutionizes, redefines, and reshapes modern economic theory, and revolutionizes and redefines the course of human civilization and human civilization itself.

### ADVANTAGEOUS EFFECTS: TWO

1. This method can completely eliminate all small, medium, large, and even extra-large enterprises producing all products, commodities, and services in all industries that are inefficient, lack productivity, and outdated, such as real estate industry, commercial aircraft manufacturing, the enterprises accounted for 25% of the US GDP under the US RFC's DPC during World War II, and power plants that buy coal with cash due to coal power shortages today.
2. This method can also eliminate random or blind production by factories and random or blind consumption by consumers.
3. This method can eradicate the massive and appalling waste generated in various industries during production and consumption due to blind production and consumption. For example, a research report on China's service industry by Alibaba Research Institute pointed out that the clothing industry in China generates waste of 400 billion yuan in the production process and 400 billion to 800 billion yuan in the consumption process each year due to blind and random production by manufacturers and blind and random consumption by consumers.
4. This method will establish a wave that includes Industry 4.0 or 5.0, namely industrial artificial intelligence.
5. This method will transform manufacturing into a service industry through the application of platform-based products using MMP_{ALL+S+SS+M} and AI artificial intelligence. Where MMP_{ALL+S+SS+M}=MMP_{ALL}+MMP_{S}+MMP_{SS}+MMP_{M}, where MMP stands for “My Model and Platform,” and My refers to Dr. Chuanping Hu.
6. Therefore, this method eliminates the traditional concept of primary, secondary, and tertiary industries, and the primary, secondary, and tertiary industries (where the primary industry refers to agriculture, forestry, animal husbandry, and fisheries (excluding agricultural, forestry, animal husbandry, and fishery services). The secondary industry refers to mining (excluding mining support activities), manufacturing (excluding metal products, machinery and equipment repair and maintenance), electricity, heat, gas, and water production and supply industries, and construction. The tertiary industry refers to the service industry, which includes all industries other than the primary and secondary industries) are integrated under this method and the MMP_{ALL+S+SS+M} platform established to achieve this method.
7. This method (1) applies to when consumers Cₙ^{m} and producers Bₙ^{m} are from different countries or regions, such as consumers Cₙ^{m} and manufacturers Bₙ^{m} in different countries, like Bₙ^{m} in China, (2) Cₙ^{m} in other countries, it creates a dual cycle of domestic and international economies, and when Cₙ^{m} Bₙ^{m} are within the same country, like in China, it creates a large domestic cycle, and (3) it involves supply-side structural reform when using more advanced and better scientific and technological means, such as artificial intelligence, to change production or satisfy constantly changing demand. (4) This method, and the platform MMP_{ALL+S+SS+M} created to implement it,

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m},

when N and M are very large, especially as N→∞ and M→∞, is equivalent to the RFC company of the United States during World War II, which accounted for 25% of the US GDP at that time. The platform and the consumers Cₙ^{m} and manufacturers Bₙ^{m} on the platform together constitute the output value equivalent to the GDP of a country or region.
8. Under this method, the enterprises and manufacturers: (1) have no advertising expenses, no sales expenses or costs, and no market expenses or costs; (2) even for some or most of the companies under the platform, there are no financial costs, that is, no loan interest costs (for companies belonging to the platform that implements this method); (3) especially for companies and manufacturers belonging to the platform; (4) because there are no above-mentioned costs that non-platforms must bear, such as advertising, marketing, sales, etc.; (5) their products, goods, and services will undoubtedly be more competitive, with better and cheaper prices; (6) because the fixed costs mentioned above must be transferred to the consumers who will pay the bill; (7) because financial support and economic activity usually account for 70% or more of the support for manufacturers.
9. Therefore, this method's revolutionary and transformative reshaping and redefining of the traditional financial industry, especially the banking sector, and the contribution of this method, this platform, and this patent to human social and economic activities, account for more than 70%.
10. The artificial intelligence and other technologies adopted by this platform, which was created to implement this method, will (1) revolutionize and redefine the vertical fields of the financial industry, banks, retail, corporate operations, investments, etc.; (2) integrate the physical world and the digital world in the financial industry under this method in the future; (3) improve efficiency, safety, and customer experience.
11. In fact, the financial institutions and banks under the platform MMP_{ALL+S+SS+M} under this method, or the financial institutions and banks closely cooperating with the platform, will achieve the ultimate efficiency, safety, and customer experience, far beyond what other financial institutions and banks in the industry can compare or compete with.
12. In fact, under this method, the financial institutions and banks generated by the platform MMP_{ALL+S+SS+M} will (1) eliminate almost all other financial institutions and banks; (2) be more thorough in their impact and change to the financial and banking industry than the so-called financial technology or fintech of Ant Group, Tencent's Wealth Management Group, and their payment tools such as Alipay or WeChat Pay, in all the businesses carried out by Ant Group, Tenpay (financial tools, functions, and attributes) in payment links, small and micro loans, Yu'ebao, etc.
13. The financial institutions and banks under the platform or closely cooperating with the platform under this method will revolutionize, reshape, and redefine the financial industry, including banks and financial institutions, in a more complete and earth-shattering way, presenting a completely different form and ecology from the traditional meaning of the financial industry, demonstrating different forms and ecologies of business civilization
14. Under this method, the impact and influence of financial technologies such as artificial intelligence that collaborate closely with or operate on the platform MMP_{ALL+S+SS+M}, which is implemented in this method, will be enormous, revolutionary, and disruptive to the banking industry. This method initially applies to payments and retail, or what is soon called “non-retail,” such as corporate loans, management without loans, and wealth management. In fact, people, consumers, or members under this method and this platform, and this patent, are more willing to use their disposable income on daily necessities such as clothing, food, housing, transportation, medical care, education, elderly care, childcare, etc., with the best global quality, lowest prices, and best value, and for investment, including housing, on this platform. As a result, manufacturers and companies under this method, platform, and patent usually do not need to borrow from banks for production, advertising, sales, marketing, and distribution because the full payment for the goods received in advance through the MMP is enough to cover these expenditures. It is conceivable that people will no longer deposit money in banks, and manufacturers and companies will no longer borrow from banks. Therefore, the lifeline and pillar business of banks and the financial industry to earn interest spreads on deposits and loans will be significantly negatively impacted, making it difficult for them to survive. Banks and financial companies under this method, platform, and patent will find it difficult to survive and may even be eliminated by banks and financial companies operating on the MMP platform.
15. This method will help and serve almost all consumers from birth to near-death around the world on the platform MMP_{ALL+S+SS+M}, which is established to implement this method.
(1) Save money.
(2) Optimize the way they spend their money.
(3) Shop or receive products from the platform after it collects information, including demand information, through artificial intelligence, and pushes the products.
(4) Buy the products with the best quality and the cheapest price (compared to similar products worldwide).
(5) Therefore, the consumers on this platform can spend their money most efficiently.
(6) In some cases, the money spent on this platform is also the best investment, with the best investment return.
(7) For example, consumers on the platform can participate in collective fundraising to buy houses at a price that is 25%-40% cheaper than the market price under the platform's organization.
(8) This is because the platform's organization does not have traditional real estate companies' interest costs incurred by borrowing from banks. Additionally, there are no costs associated with sales, marketing, or advertising for vacant properties.
(9) Therefore, compared to traditional real estate companies, people on the MMP_{ALL+S+SS+M} platform can save at least 25%-40% of the above-mentioned fixed costs when purchasing houses.
(10) In other words, people on this platform can buy houses of the same quality and value at a price that is lower than the market price or 25%-40% cheaper.
(11) Thus, consumers on the MMP_{ALL+S+SS+M} platform established by this method can immediately obtain a 25%-40% return on investment while making purchases.
(12) Buying a house is both for living and investing, and it has both usage and investment attributes.
16. This method saves people a lot of time, especially for people on the platform MMP_{ALL+S+SS+M}, or members of the platform, for what to buy, what is cost-effective, cheap, and of good quality. Furthermore, based on the available consumer spending of each consumer, this method and the platform MMP_{ALL+S+SS+M}, have made the best decisions for consumers based on artificial intelligence, including but not limited to algorithms, which determine what kind of consumers need to buy what kind of products at what stage. Additionally, the platform offers the cheapest and highest quality products in the same category globally, which are produced on demand and distributed to platform members. Especially since the platform has its own manufacturers, it can produce, supply, and distribute (after payment) products to members and consumers without the cost of advertising, sales, marketing, circulation, bank loan interest, etc.
17. This method helps poor people and reduces the poverty rate, as artificial intelligence and other platforms under MMP_{ALL+S+SS+M} can be used under the current conditions of poor people or under their disposable income. Even government subsidies or safety nets, such as Medicare and Medicaid for poor and elderly people in Western countries like the United States, and China's low-income support for poor people, can be used. Furthermore, this method and platform implementation can help poor people or those who have lifted themselves out of poverty, such as the new rural cooperative medical insurance for rural populations, and urban medical care for urban populations. “Because this method and the implementation platform MMP_{ALL+S+SS+M} can transform the limited income of poor people, including the low-income guarantee, into the satisfaction of the needs that are most needed by the poor under optimization. In other words, this method and this platform can use artificial intelligence to transform the limited income of poor people into products and commodities that best meet their needs through their own enterprise and business.”
18. This method maximizes the elimination of waste in various industries from production to circulation to consumption. For example, in the clothing industry alone, after the complete adoption and implementation of this method and platform in China, 800 billion yuan of waste can be eliminated in the production process and 400 billion yuan in the circulation and consumption process, totaling 1.2 trillion yuan of consumption waste. This does not include other industries, including but not limited to the financial, banking, and medical industries. Therefore, this method and platform are environmentally friendly and low-carbon.
19. Thus, this method and the MMP_{ALL+S+SS+M} platform can effectively respond to global climate change.
20. All global consumers or members Cₙ^{m} under this method and the MMP_{ALL+S+SS+M} platform.

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m}.

With N→∞ and M→∞, (1) “non-retail” does not refer to the traditional business concept of “wholesale.” (2) Instead, under this method and platform, manufacturers MMP_{ALL} and producers Bₙ^{m} under MMP_{S}, MMP_{SS}, MMP_{M}, or those with close cooperation with the platform, engage in direct transactions with consumers Cₙ^{m} through the platform to form a “non-retail” buying and selling behavior.
21. The platform adopts various methods, including but not limited to short video platforms, social software, and e-commerce platforms.
(1) MMP_{ALL+S+SS+M} is not only a traditional e-commerce platform, (2) but also a traditional manufacturing platform. (3) It collects demand and wallet information, (4) and enables consumers to buy all kinds of products and goods with the best global price-performance ratio and the lowest price under the “non-retail” model.
(5) Manufacturers, merchants, and enterprises under MMP_{ALL}, MMP_{S}, MMP_{SS} and MMP_{M} have an unbeatable advantage compared to those who are not on the platform or do not cooperate with the platform. As a result, they can ultimately eliminate and replace non-platform manufacturers and enterprises.
(6). Under this method and platform, manufacturers, merchants, and enterprises produce, supply, and distribute (with payment) according to demand. They do not have to bear the rigid costs that traditional companies, manufacturers, and merchants must bear, including but not limited to advertising, consumption, and market costs, and even loan interest. Moreover, they do not produce or consume blindly and randomly, resulting in no waste.
(7) For all products in all industries, such as the research released by Alibaba Research Institute on the Chinese clothing industry, there is a waste of 800 billion to 1.2 trillion yuan each year in the production and consumption processes, with 400 billion in the production process and 400 billion to 800 billion in the consumption process.
(8) Typically, these wasted costs are passed on to consumers to pay.
22. The method and platform for all Bₙ^{m} and Cₙ^{m} under MMP_{ALL+S+SS+M}=MMP_{ALL}+MMP_{S}+MMP_{SS}+MMP_{M}. For

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m}, for N→∞ M→∞ or N>No, N<No, M>Mo, M<Mo.

This method and platform deal with the supply and demand of all kinds of necessities, goods, products, and services for various age groups from birth to the end of life around the world, including food, clothing, shelter, transportation, and more, with the best quality and lowest price provided by manufacturers and enterprises driven by artificial intelligence as the core, and supplied and distributed according to the best cost-effectiveness on demand.

All kinds of needs from around the world, from birth to approaching death, for various products, goods, or services related to clothing, food, shelter, and transportation, are met through this platform by providing the best quality and lowest price, i.e., the best value for money, through production, supply, and distribution.

The best quality is mainly implemented and achieved through manufacturers and businesses powered by artificial intelligence at the core of this platform, while the lowest price is mainly achieved through consumers gathered on this platform who exchange quantity for price, which is almost equivalent to wholesale, but is actually a new type of “non-retail” in the sense that they purchase a particular product or goods in bulk and negotiate with e-commerce or life platforms for lower prices, and this platform enables them to buy the products or goods with the best quality and lowest price, i.e., the best value for money.

This platform gathers consumers to purchase the same product in large quantities and buys the best quality and lowest-priced products. The products or goods are either produced by the MMP_{ALL+S+SS+M}=MMP_{ALL}+MMP_{S}+MMP_{SS}+MMP_{M} on this platform itself, according to the needs, or are orders for customization, OEM, or OEM from the MMP_{SS} or MMP_{M} gathered on this platform and implemented, realized, and completed by the production, manufacturing, and supply according to the needs by the MMP_{ALL} or MMP_{S} or MMP_{SS} or MMP_{M} on this platform.

### DESCRIPTION OF DRAWINGS

This method and the platform MMP_{ALL+S+SS+M} created for implementing this method in reality. For

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m}. N→∞, M→∞

The working principle and implementation process of this patent. An illustrated diagram of the composition of the working principle and implementation process of this method or platform, which includes MMP_{ALL+S+SS+M}=MMP_{ALL}+MMP_{S}+MMP_{SS}+MMP_{M}, that is, MMP_{ALL+S+SS+M} consists of or is composed of four sub-platforms: MMP_{ALL}, MMP_{S}, MMP_{SS}, and MMP_{M}.

Please see FIG. 1 in the Chart (Drawing).

FIG. 1 represents the working principle and implementation process of this patent, the illustrated FIGURE of the composition of the working principle and implementation process of this method or platform, which includes MMP_{ALL+S+SS+M}=MMP_{ALL}+MMP_{S}+MMP_{SS}+MMP_{M}. That is, MMP_{ALL+S+SS+M} consists of or is composed of four sub-platforms: MMP_{ALL}, MMP_{S}, MMP_{SS}, and MMP_{M}.

(1) 1. Where Bₙ^{m} under MMP_{ALL}, the ARM manufactured under MMP_{ALL} is one of the two important components of this platform, which is manufactured under the main drive of artificial intelligence AI, and is the best quality product, commodity or service bₙ^{m} among similar products in a country or region globally.
2. The best quality product, commodity or service among similar products is produced on demand and supplied to its members or consumers through the e-commerce platform's another ARM. 3. The platform collects people's needs from birth to death worldwide through artificial intelligence. 4. And through artificial intelligence, it is promoted and customized as C2B, forming a large-scale volume procurement. 5. This makes the price the lowest among similar products through volume discounts.
(2) MMP_{S}=MMP smell 1. It is composed of manufacturers and enterprises that are not manufactured by the platform but have close cooperation with the platform. They are guided by artificial intelligence on this platform and act as OEMs for the platform, customized and sold through the platform to the platform's consumers or members.

The platform AT ensures that the quality of the product is the best among similar products and is purchased in large quantities through the platform's targeted bidding. N>No is a large level of quantity in a particular country produced and supplied by manufacturers and enterprises, which is then distributed (after payment) through the platform at the lowest price among similar products.
(3) MMP_{SS}=MMPsmall small. Except for N<No, it is basically the same as MMP_{S}. The platform can still guarantee that consumers can purchase the best quality products at the lowest price among similar products in a country or region globally, even if the quantity purchased through the platform has not reached a significant level. The price is still guaranteed to be the lowest because the enterprises and manufacturers under MMP_{SS} do not have fixed costs, advertising expenses, sales and marketing costs, and even bank loan interest costs (see Chapter 1 of this method, platform, and patent, and the relevant parts of Chapter 3 of the patent claim).
(4) MMP_{M}=Micros is a cooperation partner of the platform and accepts platform AI guidance to produce, including but not limited to OEMs for the platform, customized, reverse bidding, and sold through the platform to the platform's consumers or members. The best quality product is produced jointly with the platform AI, and the price is the lowest because it does not have the fixed costs, advertising expenses, sales, marketing costs, and even bank loan interest costs that general enterprises must have.

### BEST MODE

Example 1 in the real estate industry shows that the method and platform are feasible, workable, and can be implemented and realized, as it is a form of “non-retail” planned economy under market economics that supplies according to demand and meets the needs of consumers. This example also perfectly explains the patent claim that, under this method and platform, companies and manufacturers do not have to pay advertising, sales, or marketing costs, nor do they have to pay interest on bank loans. Consumers do not have to keep their money in the bank for a low interest rate, but can use it for collective funding and purchase products at a 25% to 40% lower price than the market price.

Moreover, companies under this method, platform, and patent do not need to borrow from banks and pay interest costs. The funds raised by consumers or members under this method, platform, and patent are sufficient to cover all the costs or funds required to build commercial housing.

Therefore, it is evident that this method, platform, and patent not only benefit consumers and members, enabling them to buy the world's best quality and lowest-priced products (commercial housing) with the highest cost-effectiveness on the platform, but also benefit manufacturers and companies under the platform, allowing them to win in the competition for similar products and eventually eliminate their competitors.

It is said that “raising funds to build houses” does not require traditional expenses such as advertising, marketing, sales, and bank loan interest because all the funds have been advanced, and the houses have been pre-ordered and purchased by all the fundraisers before the land was acquired. Therefore, the cost of the houses built with this fundraising method is 30%-40% lower than that of the commercial housing in the same city.

This also confirms and proves the enormous and revolutionary, disruptive, and transformative impact that this method, platform, and patent have on the banking and financial industries.

Personal consumers will no longer deposit their money into banks, and manufacturers and companies no longer need to borrow from banks.

As a result, the most important and essential business of the banking industry, earning the interest difference between deposits and loans, will suffer a huge impact and may even cease to exist.

It can be imagined that this example fully illustrates, confirms, and proves the method, platform, and patent, even in terms of FIGURES.

It not only has a huge revolutionary, disruptive impact and change on consumers of all skin colors, populations, and age groups worldwide but also on manufacturers and companies producing various products, goods, and services in all industries worldwide. Similarly, it has a huge revolutionary, disruptive, alternative, and eliminative impact and change on the global banking and financial industries, which may be overturned, eliminated, and replaced by this platform, method, and patent, ultimately making them no longer exist or changing their form of existence.

Moreover, since the banking and financial industries contribute more than 70% to the modern social and economic activities, 18. this method, platform, and patent will overturn, eliminate, redefine, reshape, and replace the banking and financial industries, making them no longer exist or changing their form of existence in a different way from the modern banking and financial industries.

Therefore, if the significance or contribution of this method, platform, and patent to modern social and economic activities exceeds 70%, it should not be underestimated. The significance of the invention of this method, platform, and patent by HU Chuanping lies in its revolutionary, disruptive, and redefining role in modern and contemporary commercial rules, the process of human civilization, including but not limited to the above-mentioned banking and financial industries.

Therefore, emphasizing the great significance of the invention and creation of this method, platform, and patent is not excessive.

Its milestone role in modern and contemporary commerce, economic activities, economic theories, and the process of human civilization will become increasingly prominent.

Successful Example of the MMP_{ALL+S+SS+M}=MMP_{ALL}+MMP_{S}+MMP_{SS}+MMP_{M'S} patent

This method, this platform, and this patent's successful examples in the past can indirectly confirm and demonstrate the feasibility of this patent and its claims.

Example 2: The Roosevelt New Deal from 1933 to 1985, which was implemented during the later stages of the Great Depression in the United States, was to some extent planned economics under market economics. Under this plan, banks were assisted and allocated, and factories and enterprises were directed to produce specific products and goods, successfully leading the United States out of the Great Depression and restoring its economy before, during, and after World War II, making it a superpower after the war. Roosevelt was therefore regarded as one of America's four greatest presidents. This example proves and validates an important claim of this patent, method, and platform, which is that planned economics under market economics works and is feasible.

Example 3: During World War II, the Reconstruction Finance Corporation (RFC), a public-private cooperative reconstruction finance company established by the White House and Congress in 1929 to revive the economy after the stock market crash, established the Defense Plant Corporation (DPC), which accounted for 25% of the US GDP near the end of WWII. The DPC provided loans and tax incentives for tank, aircraft, and other weapons manufacturing and provided products and services to allied countries. With the help of this defense plant company, US manufacturing capacity increased by 50% by the end of World War II, and by 1940, the company's output accounted for 25% of US GDP. The company reshaped the US aviation and electronics industries, making them one of the largest sectors in the US economy. This example proves, confirms, and validates an important claim of this patent, method, and platform from one perspective, which is that supply according to demand is safe, feasible, and effective.

Example 4: The centralized procurement of drugs and medical consumables, such as stents, by the Chinese National Medical Insurance Administration, resulted in an average price drop of more than 90% from an average price of 13,000 yuan to 700 yuan per unit. This example proves, confirms, and illustrates from one perspective that the method and platform of exchanging quantity for price is feasible. This example was only achieved in China through the power of the National Medical Insurance Administration, which represents public hospitals and patients in China, and was not specifically aimed at any particular patient or consumer. However, this patent, method, and platform are not only aimed at specific consumer groups but also specific consumers. This makes the impact of the quantity-for-price exchange even greater, and under this patent, method, and platform or patent application, consumers or consumer groups may not only include Chinese consumers but also consumers from other countries. Thus, the impact of the quantity-for-price exchange is even greater, and consumers can benefit from this method, platform, and patent application.

Examples of success related to this method, this platform, and this patent:

Example 5: Prior to the end of 2019 during the COVID-19 pandemic, especially when demand for commercial airlines was high, global airlines or aircraft leasing companies needed to pay cash, even full cash, to Boeing or Airbus, the global duopoly, to order planes that would only be delivered three to five years later. A similar situation exists for some scarce car models such as Ferrari or Lamborghini, where consumers must pay the full price months in advance before receiving the car.

This example illustrates that for global scarce or scarce commodities, consumers are willing and have to pay the full price in advance and wait for several months or even years to receive the physical products or commodities.

This example demonstrates that this method, this platform, and this patent can ensure that consumers can purchase the highest quality and lowest priced products or goods globally, from manufacturers or companies. Consumers are willing and fully able to pay the full amount in advance before receiving the physical products or goods. As a result, manufacturers or companies such as Boeing or Airbus can use consumers' money to produce and supply (after payment), thereby significantly saving interest costs of borrowing from banks. For some industries and goods, such as the example of “crowdfunding to build houses,” enterprises no longer need to borrow from banks. The full payment made by the crowdfunding buyers or homeowners in advance covers all costs, including land acquisition, construction, decoration, and landscaping, so there are no interest payments for bank loans, nor are there any rigid expenses for advertising, sales, marketing, vacancy, etc. Therefore, in the end, the consumers who “crowdfund to build houses” can buy houses at 25%-40% below market prices (the saved 25%-40% is actually saved from interest on bank loans, advertising expenses, sales costs, marketing expenses, etc.). Of course, “crowdfunding to build houses” must be carried out within the legal and non-violating limits.

This method and the implementation platform MMP_{ALL+S+SS+M} of this patent are different from traditional e-commerce platforms such as Amazon, Tmall, Taobao, Jingdong, or PDD, as well as modern e-commerce platforms such as Douyin, Kuaishou, and Xiaohongshu, and even WeChat's mini-program. Although Amazon dominates the US market, all US companies' e-commerce sales through their own e-commerce platforms account for more than 60% of the total e-commerce sales. WeChat's mini-program was only introduced as a response to this. In 2020, its GMV may have reached 1.7 trillion yuan.

This platform is not only a new type of e-commerce platform powered by AI but also an unprecedented manufacturing platform composed of N manufacturing companies where N→∞, meaning N tends to infinity.

It combines MMP_{ALL} 's own manufacturing, MMP_{S} 's close cooperation with the platform for large and medium-sized companies where N>No, MMP_{SS} 's close cooperation with small and medium-sized enterprises where N<No (see the cooperation method mentioned above), and MMP_{Micros}, the mini-program on this platform (similar to WeChat's mini-program), into a single platform. This platform is unique in that it is a manufacturing platform that includes manufacturers, including the platform's own manufacturing, and is also a new type of e-commerce platform for traditional manufacturing companies.

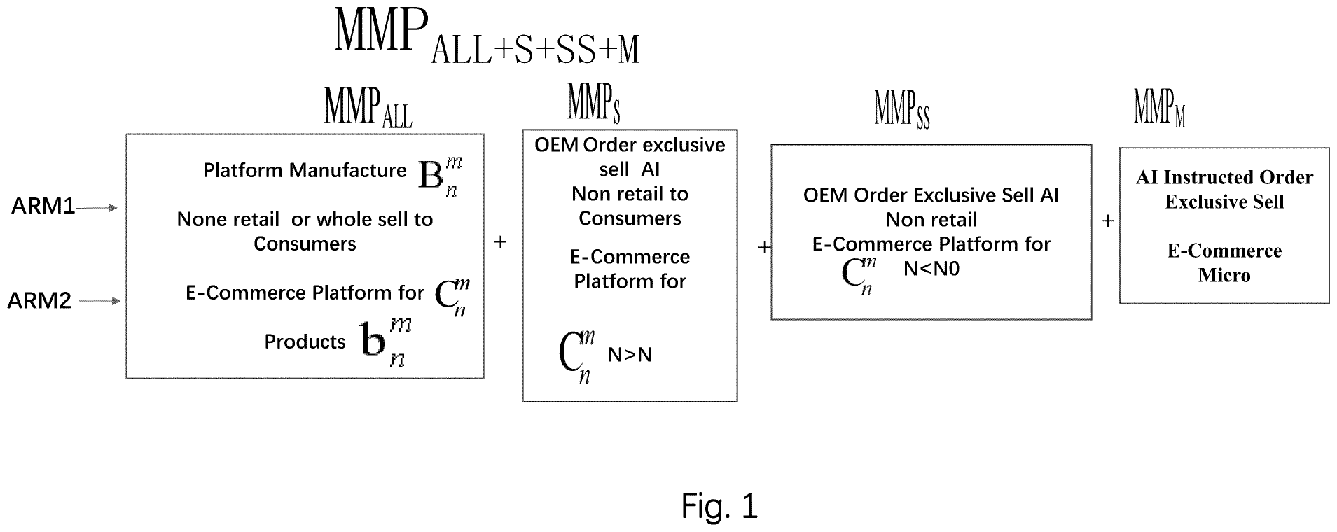

Please see FIG. 1 in the Chart (Drawing).

FIG. 1 represents the working principle and implementation process of this patent, the illustrated FIGURE of the composition of the working principle and implementation process of this method or platform, which includes MMP_{ALL+S+SS+M}=MMP_{ALL}+MMP_{S}+MMP_{SS}+MMP_{M}. That is, MMP_{ALL+S+SS+M} consists of or is composed of four sub-platforms: MMP_{ALL}, MMP_{S}, MMP_{SS}, and MMP_{M}.
(7) While Amazon, Ali, JD, and PDD basically do not have manufacturers or customizations, contract manufacturing, or package sales of ARM under AI guidance on this platform and patent.

Under the concept of “retail”, which was created and prevailed during the early days of modern business and human civilization when people did not have good ways or tools or channels or technologies to obtain necessary information for products, goods, and services or information for productions and consumption, there are no more “so-called” traditional sales to consumers. For example, manufacturers usually do not know how many products to make to satisfy the demands of consumers, let alone also face competition from competitors. Therefore, most of the time, they only manufacture products randomly or according to studies or investigations or projections, which inevitably leads to waste in production and

consumption, such as the clothing industry in China, which generates an annual waste of 1.2 trillion yuan, and costs of advertisement, sales, marketing, as well as the cost of interests of banking loans.

However, nowadays, with the discovery and development of 5G, industrial internet, e-commerce, digitalization of industry or industrialization of digital, AI, big data, cloud computation, DNA, MRNA or RUA, biotech, quantum computing using photons and computational biology, especially with the method, platform, and patent of MMP_{ALL+S+SS+M}, which revolutionizes, reshapes, and redefines the modern business rules and civilization, traditional “retail” sales will be eliminated.

### MODE FOR INVENTION

The Business Model of MMP_{ALL+S+SS+M} and

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m},

will revolutionist, reshape, redefine modern business rules and human being's process of civilization
(−) MMP_{ALL} consists of
1. N+1 acquisitions
2. M+1 bootstraps
3. O+1 joint adventures
In turn consists of the followings:
   1. “Non-retail”
   2. “Self-made” manufacturing
   3. Manufacturing the best products and goods with the help of artificial intelligence.
   4. Bₙ^{m} On-demand production, supply, and distribution Cₙ^{m} for customization, ordering, contract manufacturing, and consignment sales.

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m}, for N→∞ M→∞ or N>No, N<No, M>Mo, M<Mo.

MMP_{ALL} is the best brand for all kinds of products and goods from various industries around the world on this platform using this method.
(II) The ALL brand is implemented in the following three parts:
   1. Acquisition of the best N+1 global brands.
   2. The best quality and lowest price products and goods created by this platform itself (through AI and other technologies) in various industries with different technological levels, including high-tech and low-tech brands.
   3. Products and goods produced through cooperation with the best global platforms.
(III)
MMP_{S} consists of the following:
S stands for small for N>No or large
   1. “Non-retail” to reverse bidding.
   2. Customization+OEM+consignment production according to demand, supply, and distribution (after payment), eliminating blind random production.
   3. AI guidance provided by this platform.
   4. When the quantity of products N is at least M, manufacturers, merchants, and companies on this platform are free from financial costs such as advertising, marketing, and bank loan interest, reducing the pressure of operating costs.
   5. All MMP_{S} open virtual flagship stores on the platform, and AI is used to implement reverse bidding for bulk purchases (similar to China's National Medical Security Bureau's bulk purchase from global pharmaceutical companies). The platform uses AI to operate.
   6. The system pushes the products produced by manufacturers and companies.
(IV)
MMP_{SS} consists of the following:
SS stands for small small for N<No
   1.
   2.
   3.
   4. When the quantity of products N is less than No.
   5.
   6. The rest of the MMP_{SS} are the same as 1.2.3.5.6 in MMP_{S}.
(V) MMP_{M} stands for MMP micros consists of the followings:
   1. Similar to WeChat mini-programs, this method and platform help small and medium-sized enterprises sell products. The platform system and mini programs, with the assistance of AI, help various small and medium sized enterprises open flagship stores.
2. Bulk purchase, AI is used to implement reverse bidding, completed by the platform using AI.
3. Compared with Tmall, Taobao, Jingdong, or PDD, manufacturers and merchants operate their own flagship stores on this platform, which includes various small and medium sized enterprises' flagship stores in MMP micros. (1) The platform uses AI to open stores. (2) The operation, including selling products and goods through reverse bidding, is entirely implemented by the platform. (3) This greatly reduces the operating and marketing costs of various small and medium sized enterprises in MMP_{M}. (4) In addition to being able to receive orders for customization, OEM, and consignment through reverse bidding and other methods on this platform, small and medium-sized enterprises under this platform can also obtain consumers under the platform.
   The method and platform for all Bₙ^{m} and Cₙ^{m} under MMP_{ALL+S+SS+M} For

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite), Cₙ^{m} represents global consumers Bₙ^{m} represents manufacturers bₙ^{m} represents products (produced by manufacturers Bₙ^{m}) or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers Bₙ^{m}, for N→∞ M→∞ or N>No, N<No, M>Mo, M<Mo.

This method and platform deal with the supply and demand of all kinds of necessities, goods, products, and services for various age groups from birth to the end of life around the world, including food, clothing, shelter, transportation, and more, with the best quality and lowest price provided by manufacturers and enterprises driven by artificial intelligence as the core, and supplied and distributed according to the best cost-effectiveness on demand.

All kinds of needs from around the world, from birth to approaching death, for various products, goods, or services related to clothing, food, shelter, and transportation, are met through this platform by providing the best quality and lowest price, i.e., the best value for money, through production, supply, and distribution.

The best quality is mainly implemented and achieved through manufacturers and businesses powered by artificial intelligence at the core of this platform, while the lowest price is mainly achieved through consumers gathered on this platform who exchange quantity for price, which is almost equivalent to wholesale, but is actually a new type of “non-retail” in the sense that they purchase a particular product or goods in bulk and negotiate with e-commerce or life platforms for lower prices, and this platform enables them to buy the products or goods with the best quality and lowest price, i.e., the best value for money.

This platform gathers consumers to purchase the same product in large quantities and buys the best quality and lowest-priced products. The products or goods are either produced by the MMP_{ALL+S+SS+M}=MMP_{ALL}+MMP_{S}+MMP_{SS}+MMP_{M} on this platform itself, according to the needs, or are orders for customization, OEM, or OEM from the MMP_{SS} or MMP_{M} gathered on this platform and implemented, realized, and completed by the production, manufacturing, and supply according to the needs by the MMP_{ALL} or MMP_{S} or MMP_{SS} or MMP_{M} on this platform.

This method and platform can be mathematically proven to revolutionize, disrupt, reshape, and redefine modern business rules, the process of human civilization, and human civilization itself.

For example, this method and platform can eliminate or at least effectively reduce the waste of RMB 800 billion to 1.2 trillion in China's clothing industry each year by producing, supplying, and distributing clothing on demand in all Chinese clothing factories and by consuming clothing according to demand by all Chinese people. This example itself mathematically proves that this method and platform, or this patent claim, is superior to existing business rules and revolutionizes, disrupts, reshapes, and redefines modern business rules, as well as modern economics, whether micro or macro, the process of human civilization and human civilization.

### INDUSTRIAL APPLICABILITY

Industrial Applicability consists of MMP_{ALL+S+SS+M}=MMP_{ALL}+MMP_{S}+MMP_{SS}+MMP_{M} in Mode for Invention, Best Mode, Description of Drawings. Advantageous Effects, Technical Solution etc.

1: The method and platform created to implement this method MMP_{ALL+S+SS+M}, or simply MPP (the method, platform, patent)
$${C}_{N}^{M} ∈ {BB}_{N}^{M} {b}_{n}^{m} + {\sum }_{i = 1}^{∞} ( {AI}_{i} + {I}_{i} + {P}_{i} + ⋯ )$$
To N>No M>M or N<No M<No or N→∞ M→∞ goes to infinite patent claims.
Novel “non-retail”=“novel retail”;
This method and platform facilitate a “novel retail” or “novel non-retail” which, compared to traditional retail, is not wholesale under traditional business but rather the method by which this platform directly faces consumers on behalf of the manufacturer, selling Pₙ^{m} products or goods, or quantities of the same product or goods that are typically N>No or N<No or tend towards infinity as N→∞; In other words, products are delivered directly from the manufacturer s Bₙ^{m} to the consumers Cₙ^{m} through this platform;
Additionally, the “novel retail” or “novel non-retail” is achieved through planned economics under market economics;
This method and platform Bₙ^{m} produce, supply, and distribute (after payment) Pₙ^{m} according to the demands of the consumers Cₙ^{m} on the platform, i.e. supply Pₙ^{m} according to demands of Cₙ^{m};
The products are produced, supplied, and distributed to all people around the world, including all necessities such as clothing, food, shelter, entertainment, education, healthcare, elderly care, and child care, based on the best quality and lowest price of similar products globally, i.e., the best cost-performance ratio,
i.e., supply according demand the best of qualities and lowest prices of products, goods & services for all of the people around the world from birth to death;
The best quality is achieved through the use of artificial intelligence by the manufacturers on this platform in the design, production, and supply of products or goods for the platform's consumers or members, similar to how Apple produce the best smartphones in the same category of products; These products are not derived from market demand but are instead new products that are identified by entrepreneurs through insights into the future and analysis by artificial intelligence machines, and only these products can succeed in the market; This fundamentally disrupts the entire sales concept under this method and platform for its members and consumers;
The manufacturer under this method, platform and patent can produce, provide, and supply the best quality products, goods, or services in each industry and each product worldwide, using AI as the primary driver of the most advanced global technologies, including but not limited to big data, cloud computing, machine learning, 5G, and photon quantum computing etc.; In other words, AI is used to optimize product quality in every industry and every product;
The Method, the platform and the patent MMP_{ALL-S+SS+M} provide people best of quality products, goods and services is by or through or driven by fully utilizing or using most modern and evolving advanced all high technologies of AI which includes big data, cloud computation, machine learning 5G, photon quantum computing etc. mainly using AI in each and every industry field and in each and every product, good and services;
The lowest price and best cost-performance ratio are achieved through the aggregation of a certain quantity of consumers, which is based on the demand of the consumers Cₙ^{m} and the total demand of the same product or goods Pₙ^{m}, which is at least a quantity of N>No, to achieve the desired outcome; This is similar to China's National Healthcare Security Administration's drug and consumable quantity procurement for national public hospitals, although it is not entirely similar or the same; The difference is that the National Healthcare Security Administration estimates the quantity, while this method and platform's demand Cₙ^{m} quantity Pₙ^{m} is an exact number of N>No;
Since the products or goods under this method and platform are of the best quality and lowest price in the global market, they are naturally the products with the best cost-performance ratio among (global) similar products or goods; This means that the manufacturers on this platform produce, supply, and distribute to consumers or members globally the products or goods with the best cost-performance ratio, quality, and lowest price;
The patent aims to completely eradicate, eliminate, and eliminate the random production and consumption that has existed in the production, circulation, and consumption of goods since ancient times throughout human civilization, In another word, eliminate random production and consumption;
The method asserts that the complete eradication, elimination, and removal of blind or random production and consumption will eliminate the enormous waste resulting from the imbalance of supply and demand in various industries and products; Therefore, the method aims to eliminate waste in every industry caused by blind or random production and consumption;
For examples as pointed out by Alibaba Research Institute (see the First Finance Journal, January 2021), the Chinese clothing industry generates annual waste of 800 billion to 1.2 trillion yuan, with 400 billion yuan in production and 400 billion to 800 billion yuan in distribution and consumption; The method eliminates waste in each & every industry in each and every product in productions, distributions & consumptions;
The method proposes to eliminate inefficient and ineffective small, medium, large, and even huge enterprises in every industry and every product; Thus, the enterprises and merchants under this method and platform are the most efficient and effective in the world or in similar enterprises; Consumers and members under this method and platform can demand production, supply, and distribution according to their needs, and are supported by the method and the platform, i.e., eliminates inefficient and ineffective small, medium, large and even huge enterprises in each and every industry in each and every products, goods and/or services;
Therefore, the companies and merchants on this platform using this method are the most efficient and effective among global or similar companies; Consumers and members on this platform can exchange volume for price, produce, supply, distribute, and support the according to demand;
Furthermore, the companies and manufacturers under the method and platformer do not incur fixed costs, such as advertising costs, sales expenses, market expenses, and product storage costs in their product production, circulation, and consumption processes, and more importantly, no financial costs such as bank loan interest costs; This is because the companies and manufacturers on this platform (usually) have already received full payment from this platform for the products or goods required by consumers on this platform using this method or do not need to obtain bank loans at all, as is the case with some products or goods on this platform, such as a real estate project; For example, in the case of a commodity house, there is no need for bank loans, such as in the case of “crowdfunding to build a house”, all the funds raised or paid by buyers have already covered the entire price of the commodity house, thus eliminating the need for additional bank loans and the resulting interest costs, which in turn do not drive up house prices; Because there are no fixed costs for companies, such as advertising, sales, market, and bank loan interest, which are typically required for general companies outside of this platform, consumers on this platform can purchase commodity houses of the same quality at prices 25% to 40% lower than the market price, i.e., no cost of advertisement, sales, marketing and most of all no cost of finance or cost of banking loan, or interests are needed for most of enterprises under the method the platform and the patent;
This method and platform have no advertising fees, no sales expenses, no market expenses, and no financial or bank loan interest costs; The reason for the absence of financial or bank loan interest costs is that consumers under this platform and method have fully paid the manufacturers or companies producing products or goods under this method and platform, and thus the manufacturers or companies do not need to borrow any money from banks, as clarified and stated previously; In addition to the aforementioned, there are no advertising fees, sales expenses, or market expenses for the manufacturers and companies under this platform and method because the businesses and manufacturers under this platform and method have been reverse-bid and ordered through this platform, including but not limited to reverse ordering and customization, pushing products to consumers in advance, and supplying and distributing products based on demand at the best quality and lowest price compared to similar products; Therefore, the businesses under this method and platform can transfer the fixed costs that are typically incurred by other businesses, such as advertising fees, sales expenses, and market expenses, to consumers in the form of products that are produced and supplied on demand; This gives the manufacturers and companies under this method and platform unparalleled competitive advantages (unfair competitive advantages) in terms of pricing, quality, and sales volume, and they do not need to worry about selling their products because their products are usually sold out to consumers through this platform before production even begins, and they typically receive payment for all the products or goods in advance, thus, the businesses and manufacturers under this platform and method have not only unfair competitive advantages compared to other businesses and manufacturers that do not use this method and platform, but they can also eliminate and completely replace those businesses and manufacturers that are not competitive with them, making it impossible for them to survive in the industry; In other words, non-users of this method and platform in the industry cannot be as efficient and effective as the businesses and manufacturers under this method and platform, and this method and platform can eliminate ineffective and inefficient small, medium, large, and even huge enterprises in each and every industry in each and every product, good, and service, i.e., eliminate ineffective and inefficient small, medium, large and even huge enterprises in each and every industry in each and every products, goods and services;
This method, platform, and patent save people's time and money; Firstly, it saves money for consumers or members using this method and platform because manufacturers under this method and platform do not have the fixed costs that general companies must have, such as advertising, sales, marketing, and even interest and financial costs from bank loans; Moreover, this method and platform use guidance from artificial intelligence and other technologies to produce products specifically for consumers and offer full payment in advance for orders generated from the platform, allowing manufacturers to offer discounted or lowest prices, therefore, it is undoubtedly true that this method and platform save consumers a lot of money in most cases; In addition, according to the method and platform, when consumers or members purchase real estate from developers under this method and platform using a model similar to “crowdfunding for construction,” they can acquire the property at a price 25%-40% lower than the market price due to the absence of advertising, sales, and marketing costs, as well as the lack of interest from bank loans, hence, consumers or members using this method and platform not only save a lot of money but also obtain an investment return of about 25%-40% when purchasing properties;
This method and platform also save people's time; This is because, the platform can re-commend and provide the best quality products or goods with the lowest price and the best value for money to consumers or members at all stages of life based on their various needs; Hence, consumers or members using this method and platform do not need to spend time researching, considering, and comparing what products or goods to buy; For instance, when a new mother who lacks experience in childcare does not have enough breast milk, the platform can use artificial intelligence to re-commend the most suitable and high-quality formula at the lowest price and the best value for money for her baby, such as Feihe and Junlebao in China, which are both better in quality and price than other well-known brands in China or globally; Therefore, the mother does not need to spend any time considering what formula to buy; Another example is for white-collar women who usually spend time considering what clothes to wear for work, leisure, and at home; However, if they are consumers or members of this method and platform, the platform can re-commend and produce clothes that meet their needs seamlessly using artificial intelligence and advanced manufacturing technology, such as the Alibaba Group's advanced manufacturing project;
The method and platform MMP_{ALL+S+SS+M}
enable the entire manufacturing industry, particularly in the fashion sector, to become a service industry. This is achieved through the implementation of AI technologies in the design and production processes, as well as the collection of consumer needs on the platform, i.e., The method and the platform MMP_{AL+S+SS+M} are able to make manufacturing industry to become service industry, which means no more “so called” traditional First, Second, Third Industry anymore;
This revolutionizes the concept and statistical criteria of the traditional First, Second, and Third Industry; The fusion of these industries into one under this method and platform's AI technology applies to all industries, including both light and heavy industries; This revolutionarily redefine, reshape, redefine modern commercial rules, economic theories, and human civilization progress;
As a result, the traditional concepts of the first, second, and third industries no longer exist; The integration of the first, second, and third industries means that, under this method and platform, artificial intelligence has transformed the manufacturing industry into the service industry; There is no longer any concept or statistical criteria for the traditional first, second, and third industries; It is particularly emphasized that the transformation of the manufacturing industry into the service industry by the artificial intelligence of this method and platform is applicable to all industries, sectors, and types of businesses, not just the clothing industry mentioned in example in clothing industry (strictly speaking, the clothing industry belongs to the light industry, which is the traditional second industry); It is applicable to any other light industry (the second industry) and any other heavy industry (the third industry); This method and platform constitute why this method, platform, and patent are considered revolutionary and disruptive, reshaping and redefining the rules of modern commerce, and modern economic theory, whether it is microeconomics or macroeconomics, as well as the progress of human civilization, human being civilization and the reasons behind them;
This method and platform have created a wave (more thorough, revolutionary, disruptive, and reshaping than the first, second, third, and fourth industrial revolutions, affecting the manufacturing and service industries, and even the GDP of a country or region), including artificial intelligence, Industry 4.0, or “Smart Industry 5.0”; Leveraging unprecedented method comprehensive and unprecedented commercial rules, and unprecedented modern economic and human civilization perspectives, this method and platform have deeply revolutionized, disrupted, and reshaped modern business rules, fundamentally or at least significantly changing the principles of modern economics, the foundation of human civilization, and effective responses to global climate change and low-carbon initiatives, thereby creating a wave including, but not limited to, “Smart Industry 5.0,” “Industrial Internet,” “Digital Industrialization,” “Industrial Digitalization,” and the supply-side structural reform, consumer upgrading and sinking, domestic and international dual circulation, new development stages, concepts, and patterns, allowing the market to play a decisive role in the allocation of resources and production factors;
This patent, this method, and this platform will enable manufacturers and companies under the platform to closely collaborate with manufacturers, factories, and companies related to the platform; Even manufacturers and companies that collaborate with the platform will not incur fixed costs that are typically required by general manufacturers and must be passed on to consumers, such as advertising costs, sales expenses, market expenses, and especially financial costs such as bank loan interest; For the majority of manufacturers and companies under this patent, this method, and this platform, as claimed by “non-retail,” production and supply are based on demand, and consumers or members under the platform can order the lowest-priced and highest-quality products, goods, or services globally by paying the full price in advance; Of course, manufacturers and companies under this patent, including those closely collaborating or cooperating with the platform, will not incur advertising costs, sales expenses, market expenses, or bank loan costs; For example, “crowdfunding for housing” under this method and platform is a good and perfect example that confirms and proves there are no advertising, sales, market, or bank loan interest costs; The method also supports that this platform will completely eliminate small, medium, large, and even huge manufacturers and companies that produce various products inefficiently and ineffectively; This is because no manufacturer or company can sell products or services at the lowest price with the best quality and cost-effectiveness globally, and without incurring financial costs such as advertising, sales, market, and bank loan interest costs, at a price lower than 25%-40% below market price; Therefore, manufacturers and companies that are not under this patent, this method, or this platform, in any industry, product, goods, or service, cannot compete with manufacturers and companies under this patent, this method, or this platform, or those closely collaborating or cooperating with the platform; As a result, it won't take long for manufacturers and companies under this patent, this method, and this platform to gradually and eventually eliminate various products, goods, and service manufacturers and companies in all industries, especially inefficient and ineffective small, medium, large, and even huge manufacturers and companies, i.e., For Bₙ^{m} belongs to MMP_{ALL+S+SS+M} and sells to Cₙ^{m} for products, goods and services Pₙ^{m}, there will be no cost of advertisement, sales, marketing etc. and most of all, especially no cost of finance, no cost of interests for banking loans;

2: This method, platform, and patent claim will revolutionize, redefine, and reshape the modern commercial rules, including those of various industries, microeconomics and macroeconomics theories, the progress of human civilization and human civilization, especially the traditional financial industry, including the banking industry; Consumers or members and manufacturers under this method and platform, including but not limited to, will not need to keep their money in a bank to earn minimal interest on deposits, either for fixed or current accounts, especially in countries with high interest rates like China, where the current account interest rate is close to zero, not to mention some Western countries and Japan, where interest rates are close to or even below zero; Instead, they can put their money into this platform to use for consumption and shopping, getting the best quality, lowest priced, and most cost-effective products, goods, and services globally;
For example, as mentioned before, under this method and patent, consumers and members can crowdfund to buy land, build houses, and decorate and green them at a cost of about 25%-40% cheaper than the market price, instead of just keeping their money in a bank and earning little interest; The houses they buy are of the same quality and good as those sold on the market, and they can even get a return of 25%-40% instantly, which is much more profitable than keeping money in a bank; This applies not only to buying houses but also to almost any product, good, or service, as the manufacturers and companies under this method and platform, as mentioned in previously do not have the usual costs of advertising, sales, production, or even bank loan interest, so the products, goods, and services they sell through this platform are certainly priced lower and often much lower than those of similar products, goods, and services; This is enough to make consumers who are not under this method and platform flock to it, eager to join (for example, if a product house of the same quality sold in a city is 25%-40% cheaper, people will definitely rush to buy it, not to mention 10%-20% cheaper, which is sure to be popular, because buying it and selling it immediately can earn them 10%-20% profit, even for some people, a large sum of money, such as 10-20% of the total house price of 1 million yuan, which is 100,000-200,000 yuan);
Therefore, consumers do not need to keep their money in a bank to earn limited interest on deposits, but instead can put their money into this platform under this method and patent to be optimized and best used for people's disposable income, making their lives, work, food, clothing, housing, transportation, entertainment, medical care, and education optimal and under the guidance of the platform; At the same time, the method and the platform will have a huge impact, revolutionizing, redefining, and reshaping the banking and financial industries; Consumers under this method and platform no longer need to keep their money in a bank to earn limited interest, and manufacturers and companies no longer need to borrow from banks for production, sales, or customization of products, goods, and services, as the money provided by consumers is sufficient; Therefore, there will be no need for bank loans; Without people's deposits or enterprise loans, the lifeline of banks and the most important pillar business of earning interest on deposits and loans will cease to exist; Therefore, this method, platform, and patent will have a huge impact on the traditional financial industry;
This method, platform, and patent (MPP) revolutionize, disrupt, redefine, reshape, and change the rules of modern commerce, including those of various industries and the foundations of modern economic theory; It aims to reduce or eliminate economic crises, global supply-demand imbalances, and massive carbon dioxide emissions; This will help achieve global carbon neutrality, promote global green and low-carbon development, prevent global climate warming, and revolutionize traditional finance, including banking; For example, if this method, platform, and patent were fully implemented in China, real estate developers would no longer need to borrow from banks, potentially saving them CNY 12.3 trillion in the first half of 2021; This would also save an estimated CNY 20-23 trillion in total shadow loans, which account for 7-12% of all bank loans; The real estate industry in China is estimated to contribute about one-quarter of the country's GDP growth and is a crucial source of local government revenue and the main component of residents' wealth;
Under the method and platform, real estate developers do not need bank loans, and all payments are made in advance by consumers; This method, platform, and patent have a significant impact on Chinese real estate, potentially replacing all other real estate, and on the banking industry, potentially impacting CNY 20-23 trillion; The method and platform positively affects China's GDP growth, avoiding the risks of a crisis in individual large real estate developers and the transmission of these risks to banks and the entire Chinese economy; Its importance to China is quantitatively proven through its ability to prevent systemic risks in the real estate and banking industries;
Furthermore, this method, platform, and patent quantitatively or mathematically demonstrate their importance to the real estate, banking, economic, and GDP growth of other countries or regions; They can also prevent systemic risks in the real estate and banking industries;
This shows that this method, platform, and patent have significant impacts on: 1) the importance or replacement of all real estate in China; 2) the impact on the banking sector of 20-23 trillion yuan, where banks no longer need to lend to real estate developers; 3) the positive impact on China's GDP growth, avoiding individual real estate developers' credit crises, risks transmitted to banks, and the resulting risks to China's economy and consumer homebuyers; 4) the importance to China, particularly in eliminating or reducing the negative impact and risk caused by individual real estate developers' credit crises on themselves, the banking sector, and even the Chinese economy and consumer homebuyers;
In other words, this method, platform, and patent quantitatively or mathematically demonstrate their importance in China's real estate, banking, economy, and GDP growth, and how they can eliminate systemic risks to the real estate and banking industries; They also demonstrate their importance to other countries or regions in terms of their real estate, banking, economy, and GDP growth;
The method and platform can manage consumers' disposable income optimally and achieve the highest investment return; This is due to the method's manufacturings allow consumers or members to purchase the products, goods, and services they need at the lowest global or at least one country or region's comparable product price, with the best quality and cost-effectiveness; They can purchase the product not only for consumption but also for investment and can immediately see a return on investment;
Therefore, this method, platform, and patent optimize and reach the extreme in terms of managing the disposable income or wealth of consumers or members who join this platform through this method, platform, and patent;
Manage people's money into maximum, utilization or usages and allow people's money into greatest fullest investment returns;
This patent, method, and platform not only allows its consumers or members to achieve the maximum disposable income and even wealth as claimed previously, but also allows some products and goods to immediately achieve considerable returns; This makes the manufacturers and enterprises in various industries under this method, platform, and patent most competitive and invincible; As claimed, under the method and platform, the manufacturers are based on demand production and supply without advertising, sales, marketing expenses, or bank loan interest for production or goods, all payments are already received from consumers before production starts; Therefore, there are unfair competitive advantages in various industries, products, and goods that cannot be compared with; It ultimately eliminates small, medium, large, and even huge enterprises that are inefficient and ineffective in each and every industry in each and every product, good or service, including any small, medium, large, and even huge enterprises that do not have or enjoy this method, platform, and patent; That is to say, any enterprise that does not have or enjoy this method, platform, and patent, regardless of size, will not survive in the competition among enterprises under this method, platform, and patent and will eventually be eliminated, replaced, and removed;
This method, platform, and patent allow people's money into greatest fullest investment returns and eliminate small, medium, large and even huge enterprises in each and every industry in each and every product, good or service.
Almost any manufacturer and enterprise in any industry, product, good, or service under this method, platform, and patent does not need to borrow from traditional banks, making it impossible for traditional banks to earn interest rate differentials; They only need to work and produce under this method, platform, and patent; They can ultimately eliminate and replace competitors who do not cooperate with this method, platform, and patent and make them unable to survive;
This method, platform, and patent make manufacturers and enterprises in any industry under this platform to not incur advertising expenses, as claimed in the previous claims; This completely changes the traditional commercial rules in advertising industries in production, circulation, and consumption, making large, medium, small, and even huge manufacturers and enterprises no longer need to spend money on advertising as long as they cooperate with this method, platform, and patent; Cooperation with this method, platform, and patent can make them competitive and invincible, and ultimately replace other manufacturers and enterprises that do not cooperate with them; Conversely, any manufacturer or enterprise in any industry, product, or service that does not cooperate with this method, platform, and patent will almost be eliminated and replaced by manufacturers and enterprises under this platform, making them unable to survive, unable to compete, and ultimately eliminated; Therefore, this method, platform, and patent will redefine and reshape the advertising industry in a revolutionary and disruptive way and even eliminate the advertising industry; This will be a significant impact or challenge or change for companies that rely on advertising revenue as their main source of income, such as Google, Baidu, Facebook, TikTok, etc.
This method, platform, and patent have a tremendous impact on the sales and marketing industry, just like as mentioned before the method and platform has a huge impact on the advertising industry; This is because the manufacturers and enterprises under this method and platform do not have sales and marketing costs; Especially when this method, platform, and patent are fully launched in various countries, regions, industries, products, goods, and services globally and play a major role in all production, life, work, and economic activities of consumers, members, and manufacturers and businesses, the impact on the sales and marketing industry will be enormous; It is disruptive and could potentially replace some or all of the sales and marketing industry, including the manufacturers and enterprises which are in the sales and marketing industry;
This method, platform, and patent help the poor and reduce poverty; This is because, as stated in the previous claim, this method, platform, and patent enable people (consumers or members) worldwide to meet their demand under disposable income in the best and most cost-effective way, and obtain the best return (optimize the disposed income of those people including the poor) for products and goods such as housing; It also helps these families manage their money and optimize their income; Therefore, it helps the poor by allowing them to live the best life possible under limited disposable income and by minimizing the compulsory spending on healthcare, for example, by accomplishing the most with minimal money through volume discounts similar to China's National Medical Insurance Administration's volume procurement of heart stents from an average price of 13,000 yuan to 700 yuan; This method, platform, and patent could undoubtedly reduce poverty by helping these poor people and prevent them from becoming impoverished due to illness;

3: This method, this platform, this patent are green and low-carbon;
Green and low-carbon; As claimed in the previous claims of this method, this platform, and this patent, including but not limited to the enormous waste produced in the production, circulation, and consumption processes of various products, goods, and services in various industries, such as the waste of about 400 billion yuan in the production and circulation of China's clothing industry each year and the waste of 400-800 billion yuan in consumption, resulting in a total waste of about 800 billion to 1.2 trillion yuan each year; The production value of clothing worth 800 billion to 1.2 trillion yuan requires electricity, water, labor, materials, office space, factories, etc., which will inevitably generate corresponding carbon dioxide emissions and is not green and low-carbon;
Therefore, this method, this platform, and this patent can eliminate waste in various industries, products, goods, and services, and become green and low-carbon;
This method, this platform, this patent can help cope with global climate change;
This is because this method and the platform can become green and low-carbon, which is the most important method and tool for people to cope with climate change; Therefore, this method, this platform, and this patent can help cope with global climate change;
This method, this platform, this patent totally change the way people living in the world on the earth, similar to Edison's invention of electricity, electronic computers, the internet, smartphones, etc., which changed people's lifestyles and workstyles;
The method, the platform, the patent totally change the way people living in the world on the earth; Because people, especially those under this method, this platform, and this patent, consumers, members no longer need to spend time considering what to buy, how to sell, what is the most cost-effective, including wealth management, etc. All the claims of this patent, this method, this platform, MMP_{ALL+S+SS+M},
help people make the best decisions, so people can spend their precious time on more creative and valuable things and accompany their families.
This method, this platform, this patent revolutionarily overturn, redefine, reshape, and change modern business rules, including but not limited to “new retail enables manufacturers and consumers to trade directly through this platform,” “planned economy under a market economy,” “on-demand production, supply, distribution,” “no fixed costs required for advertising, sales, marketing, or even bank interest for manufacturers under this platform,” “no random production by manufacturers and random consumption by consumers,” “thoroughly eliminate waste in production and consumption processes,” “replace, consume, and completely eliminate small, medium, large, and even huge enterprises in every industry for every product, commodity, or service that have no efficiency or effectiveness,” “consumers can buy the world's best quality, lowest-priced, and most cost-effective products, goods, or services,” “save people's time and money,” “help the poor and reduce poverty,” “like green and low-carbon,” “help cope with global climate change,” etc.; Therefore, this method, this platform, and this patent change the way people work and live and also change the way enterprises produce products;
This method, platform, and patent revolutionarily overturn, redefine, reshape, change, and replace modern economic theories, including micro and macroeconomics, because this method, platform, and patent alter, replace, overthrow, redefine, and reshape the modern commercial rules that constitute the core and foundation of modern economic theories to a considerable extent;
This method, platform, and patent revolutionarily overturn, redefine, reshape, and change the progress of human civilization and human civilization itself because this method, platform, and patent revolutionarily overturn, redefine, and reshape modern commercial rules and fundamentally change consumer behavior in consumption and production behavior in the production process; Therefore, this revolutionary overturn, redefinition, and reshaping of modern economic theories and human civilization;
This method, platform, and patent completely eliminate periodic economic crises in Western countries and all countries; This patent balances demand and supply, and economic crises mainly result from imbalances between demand and supply; However, under this method and platform, production supply is in accordance with demand and thoroughly eliminates stochastic production and consumption, therefore, this method, platform, and patent completely eliminate periodic economic crises;

4: This method, platform, and patent MPP can quantitatively estimate the positive impact of this patent on global warming or the quantitative suppressive or reducing effect on global warming when fully implemented, substantially implemented, or mostly implemented, which plays an irreplaceable and immeasurable positive and crucial role in U.S. UK. Canada. China etc's carbon neutrality and global climate change response;
According to the Nobel Laureate in Physics on Oct. 5, 2021, Syukuro Manabe, a senior meteorologist at Princeton University in the United States, published the classic paper “Thermal Equilibrium of the Atmosphere with Given Distribution of Relative Humidity” in the Journal of Atmospheric Sciences in 1967; It was the first to use a simplified one-dimensional radiation-convection model to discuss the impact of factors including carbon dioxide on global warming and quantitatively estimate the impact of carbon dioxide on global change internationally (see Caixin Weekly, Oct. 11, 2021, Issue 39, Issue 975, page 72);
Therefore, with complete or partial implementation of this method, platform or patent, especially with complete implementation of this patent, this patent can completely eliminate or thoroughly reduce the very serious waste in every industry, even in every product, during production, distribution, and consumption processes globally; Some industries, such as China's catering and clothing industries, have waste that is shocking, reaching 25% or 33% of the entire catering or service industry annually; For example, as reported by the Alibaba Research Institute (see the First Finance, January 2021), the Chinese clothing industry generates annual waste of 800 billion to 1.2 trillion yuan, with 400 billion yuan in production and 400 billion to 800 billion yuan in distribution and consumption; And the production of 800 billion to 1.2 trillion yuan of clothing inevitably requires water, electricity, space, and labor, all of which inevitably emit a certain amount of carbon dioxide;
Therefore, Syukuro Manabe's work, which quantitatively estimated the impact of carbon dioxide on global climate warming and MPP's patent, which includes but is not limited to the elimination of waste annually and globally in each and every industry in each and every product, good, and service, as well as the Alibaba Research Institute's report on the waste situation in China's clothing industry, can quantitatively estimate the reduction of carbon dioxide emissions after complete or partial implementation of MPP's patent, thereby positively impacting global warming, including but not limited to planning and building steps and plans to achieve China's national carbon peak and carbon neutrality goals, as well as the United States and other countries' carbon peak and carbon neutrality goals=The applicant of Dr. Chuanping Hu's patent theoretically and should be awarded the Nobel Prize in Physics;
The applicant of Dr. Chuanping Hu's patent theoretically and should also be awarded the Nobel Prize in Economics because the patent can eliminate cyclical economic crises in Western countries or market economies or completely market-based economies; As claimed previously, this method, patent, and platform eliminate or completely reduce the imbalance between supply and demand, which is the main root cause of economic crises;
As claimed previously, this method, platform, and claim not only redefine, reshape, and revolutionize the theoretical foundation of modern macroeconomics but also redefine, reshape, and revolutionize the foundation of modern microeconomics and macroeconomics in turn process of human being civilization and human being civilization.
